(19) United States
(12) Patent Application Publication
(10) Pub. No.: US 2002/0193964 A1
(43) Pub. Date: Dec. 19, 2002

(54) Tape measurer having a recording device

(76) Inventor: Chao Fa Hsu, Taichung (TW)

Correspondence Address: Chao Fa Hsu, P.O. Box 63-99, Taichung, 406, TW

(21) Appl. No.: 09/879,697

(22) Filed: Jun. 13, 2001

(51) Int. Cl. G01B 3/02

(52) U.S. Cl. 702/161; 33/706; 340/693.5

(57) ABSTRACT

A tape measurer includes a housing, a flexible measuring tape rule received in the housing in a coiled position, and a device including an integrated circuit or a processing unit for recording and displaying purposes. The measured data may be easily and quickly recorded in the recording circuit or the integrated circuit or in the processing unit and may be displayed after all the required data have been measured and recorded, such that the measuring operations may thus be quickly conducted or proceeded. A laser device may generate a laser beam to indicate far away points.

### BACKGROUND OF THE INVENTION

1. Field of the Invention

The present invention relates to a tape measurer, and more particularly to a tape measurer including a recording device for recording the measured data.

2. Description of the Prior Art

Typical tape measurers includes a flexible measuring tape rule received in a coiled position in a housing. The measuring tape rule may be pulled outward of the housing for measuring purposes. However, the users have to record the measured data with their hands and with pens after each measuring operation.

The present invention has arisen to mitigate and/or obviate the afore-described disadvantages of the conventional tape measurers.

### SUMMARY OF THE INVENTION

The primary objective of the present invention is to provide a tape measurer including a recording device for recording the measured data and for avoiding the users to record the data with the hands and with the pens.

The other objective of the present invention is to provide a tape measurer including a laser device for indicating far away points.

In accordance with one aspect of the invention, there is provided a tape measurer comprising a housing, a flexible measuring tape rule received in the housing in a coiled position, and means for recording measured data.

The recording means includes an integrated circuit for recording and displaying purposes, or the recording means includes a processing unit for recording and displaying purposes. The measured data may be easily and quickly recorded in the recording circuit or the integrated circuit or in the processing unit and may be displayed after all the required data have been measured and recorded, after each measuring operation, such that the measuring operations may thus be quickly conducted or proceeded.

The recording means includes a microphone for receiving sound waves, and includes a speaker for output sounds.

A laser device may further be provided for generating a laser beam and for indicating far away points or for locating or positioning purposes.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a tape measurer in accordance with the present invention;

FIG. 2 is a front view of the tape measurer;

FIG. 3 is a right side view of the tape measurer;

FIG. 4 is a front view of the tape measurer, similar to FIG. 2, in which one half of the housing is removed for illustrating the inner structure of the tape measurer; and

FIGS. 5, 6, 7 are cross sectional views taken along lines 5-5, 6-6, and 7-7 of FIG. 2 respectively, for illustrating the inner structure of the tape measurer.

### DETAILED DESCRIPTION OF THE PREFERRED EMBODIMENT

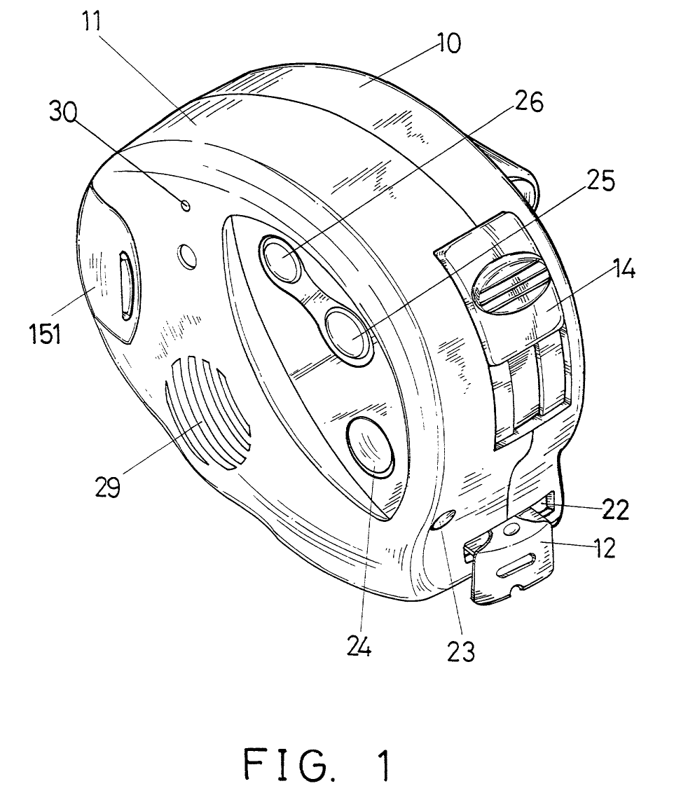

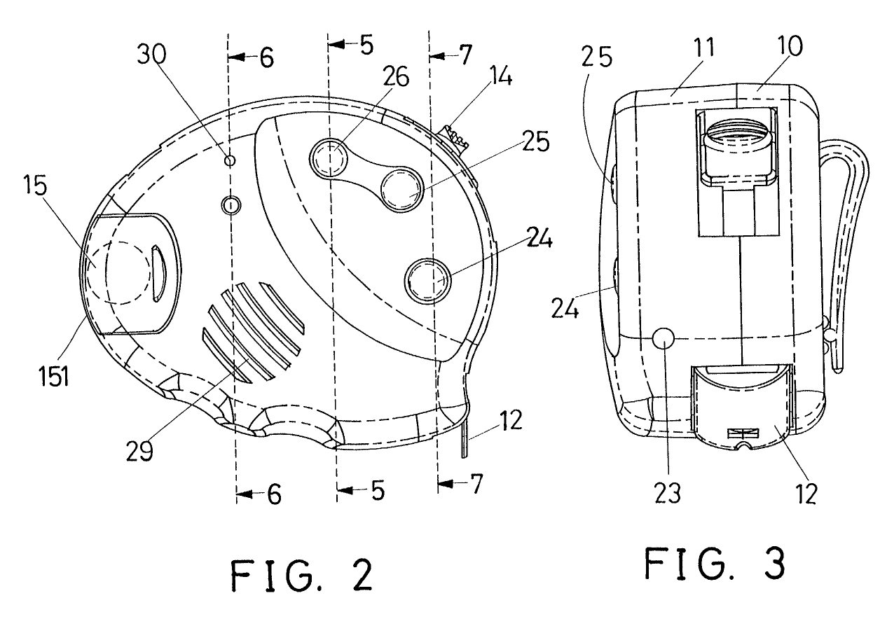

Referring to the drawings, and initially to FIGS. 1-4, a tape measurer in accordance with the present invention comprises a housing 10, 11 including two housing members 10, 11 secured together with such as the force-fitted engagement, with fasteners, with lock latches, with welding processes or the like, and including an axle 31 provided therein. A flexible measuring tape rule 12 is received in the housing 10, 11 and engaged on the axle 31 in a coiled position, and may be pulled outward through a slot 22 of the housing 10, 11 for measuring purposes. A finger operatable button 14 is on the housing 10, 11 for engaging with the tape rule 12 and for selectively locking the tape rule 12 to the housing 10, 11 at the selected or required outward pulled position. A coil spring or the like may be received in the housing 10, 11 and engaged with the tape rule 12 for recovering or for pulling the tape rule 12 inward of the housing 10, 11 to the coiled position. The above tape measurer configuration is typical and will not be described in further details.

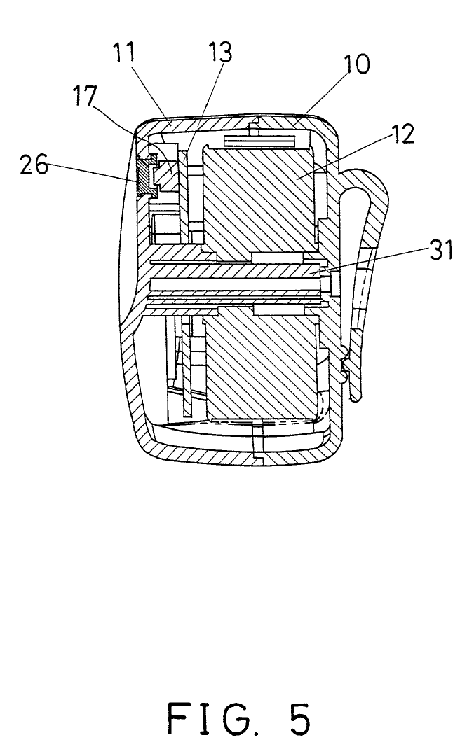

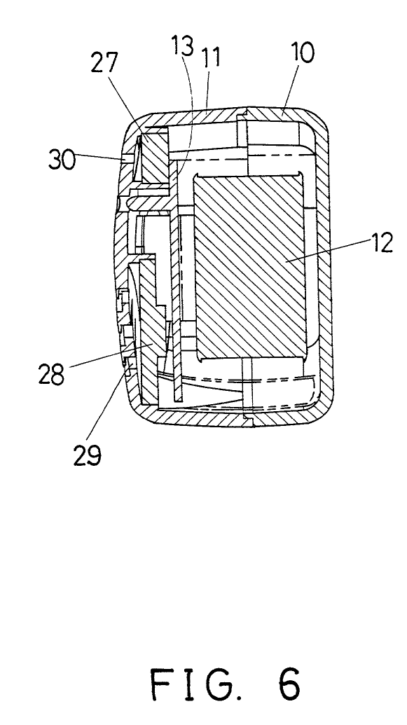

One or more batteries 15 may be received in the housing 10, 11 which includes an openable cap 151 attached thereto for enclosing the housing 10, 11 and for retaining the batteries 15 within the housing 10, 11. A circuit board or an integrated circuit 13 is received in the housing 10, 11, and includes a recording device or recording circuit provided therein, or includes a processing unit 17 (FIG. 5) provided therein or coupled thereto for recording the measured date. A memory or the like may be coupled to the circuit board or the integrated circuit 13 for saving the recorded data. A switch button 25 may be used to actuate the recording circuit or the integrated circuit 13 or the processing unit 17 to record the required information, and the other switch button 26 may be used to display the recorded data. A microphone 27 and a speaker 28 are received in the housing 10, 11 and coupled to the circuit board or the integrated circuit 13 for receiving sound wave and for generating the sounds. The housing 10, 11 includes two openings 29, 30 communicating with the speaker 28 and the microphone 27 respectively for allowing the sound waves to be transmitted inward and outward of the housing 10, 11.

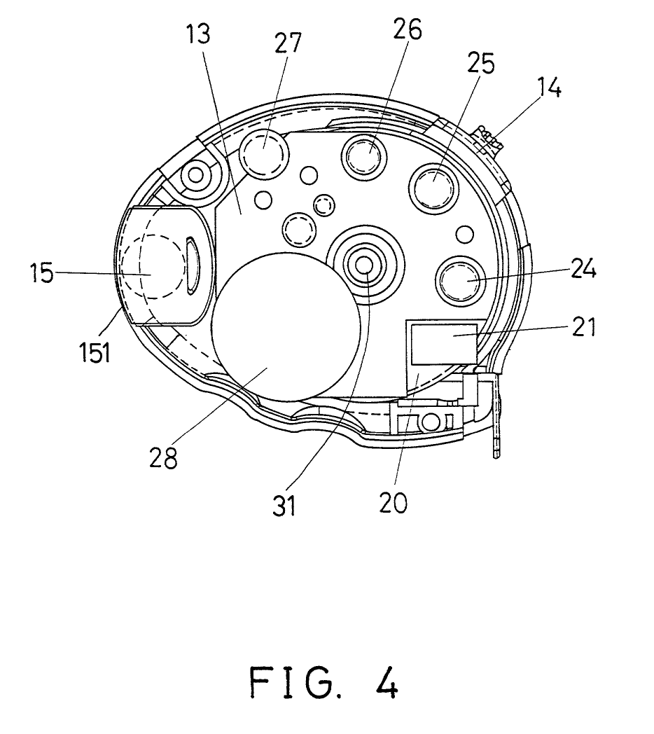

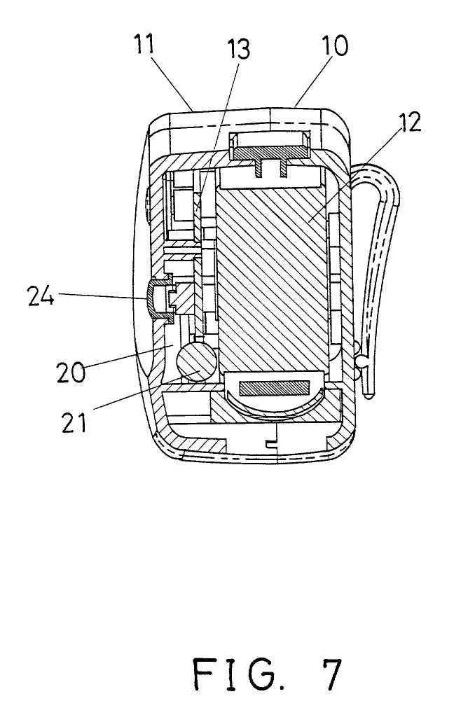

The housing 10, 11 includes a chamber 20 formed or provided therein (FIGS. 4, 7) for receiving a laser device 21 therein, and includes an orifice 23 formed therein (FIGS. 1, 3) and aligned with the laser device 21, for allowing the laser beam generated by the laser device 21 to be emitted outward of the housing 10, 11 through the orifice 23 of the housing 10, 11. A switch button 24 may be used to actuate the laser device 21 directly or indirectly via the integrated circuit 13 or the processing unit 17 in order to generate a laser beam and to indicate far away points. The batteries 15 are electrically coupled to the electric devices, such as the integrated circuit 13, the processing unit 17, the microphone 27, the speaker 28, the laser device 21, etc., for energizing the electric devices.

In operation, after each measuring operation, the user may speak out the measured data which may be recorded in the recording circuit or the integrated circuit 13 or in the processing unit 17 and which may be displayed after all the required data have been measured and recorded. The measuring operations may thus be quickly conducted or proceeded.

Accordingly, the tape measurer in accordance with the present invention includes a recording device for recording the measured data and for avoiding the users to record the data with the hands and with the pens, and includes a laser device for indicating far away points.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tape measurer comprising:
a housing,
a flexible measuring tape rule received in said housing in a coiled position, and
means for recording measured data.

2. The tape measurer according to claim 1, wherein said recording means includes an integrated circuit for recording and displaying purposes.

3. The tape measurer according to claim 1, wherein said recording means includes a processing unit for recording and displaying purposes.

4. The tape measurer according to claim 1, wherein said recording means includes a microphone for receiving sound waves, and includes a speaker for output sounds.

5. The tape measurer according to claim 1 further comprising a laser device for generating a laser beam.

6. A tape measurer comprising:
a housing,
a flexible measuring tape rule received in said housing in a coiled position, and
a laser device for generating a laser beam.

7. The tape measurer according to claim 6 further comprising means for recording measured data.

8. The tape measurer according to claim 7, wherein said recording means includes an integrated circuit for recording and displaying purposes.

9. The tape measurer according to claim 7, wherein said recording means includes a processing unit for recording and displaying purposes.

10. The tape measurer according to claim 7, wherein said recording means includes a microphone for receiving sound waves, and includes a speaker for output sounds.
